(19) United States
(12) Patent Application Publication
(10) Pub. No.: US 2023/0383095 A1
(43) Pub. Date: Nov. 30, 2023

(54) FLAME-RETARDANT POLYAMIDE GLASS FIBER COMPOSITION AND PREPARATION METHOD THEREFOR

(71) Applicants: Cathay Biotech Inc., Shanghai (CN); CIBT America Inc., Newark, DE (US); Shanxi Synthetic Biology Institute Co., Ltd., Taiyuan (CN); Cathay (Taiyuan) Biomaterial Co., Ltd., Taiyuan (CN)

(72) Inventors: Yuanping Li, Shanghai (CN); Bing Guan, Shanghai (CN); Xiucai Liu, Shanghai (CN)

(73) Assignees: Cathay Biotech Inc., Shanghai (CN); CIBT America Inc., Newark, DE (US); Shanxi Synthetic Biology Institute Co., Ltd., Taiyuan (CN); Cathay (Taiyuan) Biomaterial Co., Ltd., Taiyuan (CN)

(21) Appl. No.: 18/448,642

(22) Filed: Aug. 11, 2023

Related U.S. Application Data
(63) Continuation-in-part of application No. 18/357,900, filed on Jul. 24, 2023, now abandoned.
Application No. 18/357,900 is a continuation-in-part of application No. PCT/CN2022/072934, filed on Jan. 20, 2022.

(30) Foreign Application Priority Data
Jan. 25, 2021 (CN) 202110097373.5

(51) Int. Cl. C08K 7/14; C08K 3/32

(52) U.S. Cl. CPC C08K 7/14; C08K 3/32; C08K 2003/329

(57) ABSTRACT

Provided are a flame-retardant polyamide glass fiber composition and a preparation method therefor. The flame-retardant polyamide glass fiber comprising 40-65 parts by mass of a polyamide resin, 25-40 parts by mass of glass fibers, 0-20 parts by mass of a flame retardant, 0.2-1 part by mass of an antioxidant and 0.1-2 parts by mass of other auxiliaries. The flame-retardant polyamide glass fiber composition provided in the present disclosure not only has a bio-based source, but also has a flame-retardant of V-0 in UL94 and excellent mechanical properties, and can be widely applied to the fields of various engineering plastics with high requirements for flame retardant effect and dimensional stability.

### CROSS-REFERENCE TO RELATED APPLICATIONS

This application is a continuation-in-part of U.S. patent application Ser. No. 18/357,900, filed Jul. 24, 2023, which is a continuation-in-part of PCT Application No. PCT/CN2022/072934, filed Jan. 20, 2022, which claims the priority of Chinese Patent Application CN202110097373.5, filed Jan. 25, 2021, the entire content of the applications being incorporated herein by reference.

### TECHNICAL FIELD

The present disclosure relates to the field of engineering plastic technology, and specifically to a flame-retardant polyamide glass fiber composition and a preparation method therefor.

### BACKGROUND

Polyamide (PA) has excellent comprehensive performance of wear resistance, self-lubrication, easy processing, solvent resistance, high mechanical strength, etc., and higher specific strength than a metal. Polyamides commonly used in engineering plastics are polyamide 6 and polyamide 66, although they have certain flame-retardant, and still cannot meet the requirements of modern people's life and industrial development for flame-retardant property.

Modifications are often needed to improve flame-retardant. Thus, a polyamide composite material with high flame-retardant and good mechanical properties and a preparation method thereof are urgently needed in the field.

### SUMMARY

One embodiment of the disclosure provides a flame-retardant polyamide glass fiber composition. The flame-retardant polyamide glass fiber composition includes, 40-65 parts by mass of a polyamide resin, 25-40 parts by mass of glass fibers, 0-20 parts by mass of a flame retardant, 0.2-1 part by mass of an antioxidant and 0.1-2 parts by mass of other auxiliaries.

One embodiment of the disclosure also provides a preparation method of the flame-retardant polyamide glass fiber composition. The preparation method includes the following steps of: mixing the polyamide resin, the glass fibers, the flame retardant, the antioxidant and other auxiliaries, preferably kneading by a melt extruder, and more preferably kneading by a twin-screw extruder.

The flame-retardant polyamide glass fiber composition disclosed by the embodiment of the disclosure not only has a bio-based source, but also has the flame-retardant property of UL94 up to V-0 grade, has excellent mechanical properties, and can be widely applied to the fields of various engineering plastics with higher requirements for flame-retardant effect and dimensional stability.

### DETAILED DESCRIPTION

Typical embodiments that reflect the characteristics and advantages of the present disclosure will be described in detail in the following description. It should be understood that the present disclosure can have various variations in different implementation methods, which do not deviate from the scope of the present disclosure, and the descriptions therein are essentially intended for illustrative purposes rather than limiting the present disclosure.

The present disclosure provides a flame-retardant polyamide glass fiber composition, including 40-65 parts by mass of a polyamide resin, 25-40 parts by mass of glass fibers, 0-20 parts by mass of a flame retardant, 0.2-1 part by mass of an antioxidant and 0.1-2 parts by mass of other auxiliaries.

The flame retardant is preferably 5-20 parts by mass. The polyamide resin includes repeat units derived from pentanediamine and a diacid. The diacid includes an aliphatic diacid and an aromatic diacid. The aliphatic diacid is selected from succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, and octadecanedioic acid. The aromatic diacid includes one or more of terephthalic acid, isophthalic acid, phthalic acid, and a mixture thereof.

The molar ratio of pentanediamine to the diacid is 1-1.05:1.

In some embodiments, pentanediamine may be prepared from a bio-based feedstock by fermentation or enzymatic conversion.

In some embodiments, the molar ratio of pentanediamine to the diacid is 1.05:1.

In some embodiments, the diacids are adipic acid and terephthalic acid, and the molar ratio of adipic acid to terephthalic acid is 1:0.1-1.5, preferably 1:0.3-1.3, more preferably 1:0.4-0.9.

In some embodiments, the relative viscosity of the polyamide resin in 96% concentrated sulfuric acid at 25° C. is 1.8-4. The relative viscosity is measured by Ubbelohde viscometer concentrated sulfuric acid method: 0.25+/−0.0002 g of the dried polyamide resin is accurately weighed, and 50 mL of concentrated sulfuric acid (96 wt %) is added to dissolve, and measure and record the flow time to of the concentrated sulfuric acid and a polyamide sample solution flow time t in a 25° C. constant temperature water bath. Relative viscosity calculation formula: relative viscosity=t/t₀, wherein t represents the solution flow time and t₀ represents the solvent flow time.

In some embodiments, the relative viscosity of the polyamide resin in 96% concentrated sulfuric acid at 25° C. is 1.8-3.5.

In some embodiments, the relative viscosity of the polyamide resin in 96% concentrated sulfuric acid at 25° C. is 2.5-3.2.

In some embodiments, the melting point of the polyamide resin is 200-318° C.

In some embodiments, the melting point of the polyamide resin is 260-308° C.

In some embodiments, said polyamide resin has an amino terminal group concentration of 20-100 mmol/kg.

In some embodiments, the polyamide resin has a melting point of 260-278° C., a moisture content of 800 ppm to 2000 ppm, and an amino terminal group content of 45-55 mmol/kg.

In some embodiments, the preparation method of the polyamide resin includes the following steps of: (1) raising the temperature of a reaction device to 40° C. to 80° C., such as 45° C., 50° C., 60° C., 65° C., 70° C., 75° C. and the like, and mixing water, pentanediamine and a diacid in an inert gas atmosphere to prepare a polyamide salt solution with a concentration of 30-70 wt %; (2) transferring the aqueous polyamide salt solution into a polymerization device, heating under inert gas atmosphere, increasing the temperature in the kettle to 230-310° C., increasing the pressure in the polymerization device to 0.7-2.5 MPa, and maintaining for 60-180 min; then in 30-120 minutes, exhausting the gas and depressurizing to normal pressure, and at the same time, increasing the temperature in the polymerization device to 260-340° C.; evacuating and depressurizing in the polymerization apparatus to −0.02 to −0.08 MPa and maintaining for 30-120 minutes to obtain the polyamide resin.

In some embodiments, the reaction apparatus is a salt-forming kettle and the polymerization apparatus is a polymerization kettle.

In some embodiments, when the aqueous polyamide salt solution is sampled and diluted to a concentration of 10 wt %, the pH is controlled to 7.5-9.0.

In some embodiments, the inert gas includes nitrogen, argon or helium.

In some embodiments, the concentration of the polyamide salt solution may be 45 wt %, 50 wt %, 55 wt %, 60 wt %, 65 wt %, 70 wt % or 75 wt %.

In some embodiments, the polyamide resin and the glass fiber are in a mass ratio of 49-65:25-40.

In some embodiments, the glass fibers include any one of E-Glass fiber (or called high-quality general type glass fiber), S-Glass fiber (or called high-strength type glass fiber), D-Glass fiber (or called low-density type glass fiber), C-Glass fiber (or called low-performance ordinary type glass fiber), L-Glass fiber (or called radiation-resistant type glass fiber), and M-Glass fiber (or called high-modulus type glass fiber).

In some embodiments, the glass fibers are preferably chopped glass fibers having a length of 3-5 mm.

In some embodiments, the flame retardant is present in an amount of 5 to 12 parts.

In some embodiments, the flame retardant includes one or more of a phosphorus-containing flame retardant, a halogen flame retardant, a nitrogen-based flame retardant and an inorganic flame retardant, and one of synergists such as antimony trioxide, zinc borate and the like.

In some embodiments, the phosphorus-containing flame retardant includes one or more of aryl monophosphate, aryl bisphosphate, alkyl dimethyl phosphate, triphenyl phosphate, tricresyl phosphate, tri(xylenyl)phosphate, propylbenzene series phosphate, butylbenzene series phosphate, or hypophosphite.

Preferred hypophosphite salt is an organic metal hypophosphite, such as metal methylethylhypophosphite and metal diethylhypophosphite. More preferably, it is aluminum methylethylhypophosphite, aluminum diethylhypophosphite, zinc methylethylhypophosphite and zinc diethylhypophosphite. More preferably, the flame retardant is aluminum hypophosphite, magnesium hypophosphite, calcium hypophosphite and/or zinc hypophosphite, and more preferably, the flame retardant is aluminum hypophosphite, aluminum diethylhypophosphite and/or zinc diethylhypophosphite.

In some embodiments, the halogen flame retardant is selected from one or more of hexabromocyclododecane, decabromodiphenyl ether, octabromodiphenyl ether, tetrabromobisphenol A, bis(tribromophenoxy)ethane, bis(pentabromophenoxy)ethane, tetrabromobisphenol A epoxy resin, tetrabromobisphenol A carbonate, ethylene bis(tetrabromophthaloyl)imide, ethylenebispentabromodiphenyl, tris(tribromophenoxy)triazine, bis(dibromopropyl)tetrabromobisphenol A, bis(dibromopropyl) etrabromobisphenol S, brominated polyphenylene ether, brominated polystyrene, brominated cross-linked aromatic polymer, brominated epoxy resin, brominated phenoxy resin, brominated styrene-maleic anhydride copolymer, tetrabromobisphenol S, tris(tribromoneopentyl)phosphate, polybromotrimethylphenylindane, tris(dibromopropyl)isocyanurate.

In some embodiments, the nitrogen-based flame retardant includes, for example, melamine cyanurate, melamine polyphosphate, melamine pyrophosphate, melamine phosphate, bismelamine pyrophosphate, melam polyphosphate, or melem polyphosphate, and preferably has a phosphorus content of 2 or more, and more preferably 10.

In some embodiments, the inorganic flame retardant includes metal hydroxides such as magnesium hydroxide, calcium hydroxide, calcium aluminate, aluminum hydroxide, etc., zinc borate, zinc phosphate and other zinc salts, etc.

In some embodiments, the flame retardant is a combination of the halogen flame retardant and the phosphorus-containing flame retardant or a combination of the halogen flame retardant and the nitrogen-based flame retardant

In some embodiments, the flame retardant is selected from any two of aluminum diethylhypophosphite, decabromodiphenyl ether, and melamine polyphosphate.

In some embodiments, the flame retardant is a combination of aluminum diethylhypophosphite and decabromodiphenyl ether, and the weight ratio of aluminum diethylhypophosphite to decabromodiphenyl ether is 3 to 5:1, such as 3:1, 4:1 or 5:1.

In some embodiments, the flame retardant is a combination of melamine polyphosphate and decabromodiphenyl ether in a weight ratio of 4-6:1

In some embodiments, the antioxidant is selected from one or more of hindered phenolic antioxidants, hindered amine antioxidants, or phosphite antioxidants.

Preferably, the antioxidant is selected from one or more of commercially available antioxidant 168, antioxidant 1098, antioxidant 1010, and antioxidant S9228.

In some embodiments, the auxiliaries include, but are not limited to, one or more of lubricants, colorants, UV absorbers, light stabilizers, antistatic agents, or plasticizers.

The lubricant preferably includes an internal lubricant montan wax, such as commercially available WAX-E, and/or an external lubricant amide wax (such as commercially available WAX-C), stearate or ethylenebis-stearamide.

In some embodiments, the flame-retardant polyamide glass fiber composition includes, in parts by weight: 49-64 parts of polyamide resin, 30-40 parts of glass fiber, 8-12 parts of flame retardant, 0.2-0.4 part of antioxidant and 0.3-0.6 part of lubricant, wherein the total weight part of the raw materials is 100 parts by weight.

In a second aspect, the present disclosure provides a preparation method of the flame-retardant polyamide glass fiber composition as described above, and the preparation method includes mixing polyamide resin, glass fiber, flame retardant, antioxidant and other auxiliaries, preferably kneading by a melt extruder, more preferably kneading by a twin-screw extruder.

In some embodiments, the preparation method includes: adding the polyamide resin, the flame retardant, the antioxidant and other auxiliaries into a stirrer, and mixing to obtain a premix, melting at 15-40° C. higher than the melting point of the polyamide resin, and adding glass fiber into the premix, mixing, extruding and cooling to obtain the flame-retardant polyamide glass fiber composition.

In some embodiments, during melt-kneading, the premix is fed into a parallel twin-screw extruder through a feeder for melt extrusion, and granulation, in which the parallel twin-screw extruder is in eight-zone heating mode, and its technological parameters are as follows: the temperature of the first zone is 250-270° C., the temperature of the second zone is 270-290° C., the temperature of the third zone is 290-320° C., the temperature of the fourth zone is 290-320° C., the temperature of the fifth zone is 290-320° C., the temperature of the sixth zone is 290-320° C., the temperature of the seventh zone is 290-320° C. and the temperature of the eighth zone is 290-320° C., in which the direction from the first zone to the eighth zone is the direction from feed inlet to machine head.

In some embodiments, the machine head temperature of the twin-screw extruder is 285-315° C.

In some embodiments, the twin-screw extruder has a screw rotation speed of 350-500 r/min.

In some embodiments, the main feed rotation speed of the twin-screw extruder is 10-100 r/min, and the side feed rotation speed of the twin-screw extruder is 1-100 r/min.

In some embodiments, the twin-screw extruder has an aspect ratio of 1:(30-50), preferably 1:36.

The present disclosure also provides a flame-retardant polyamide glass fiber composition, which has a tensile strength of 170-220 MPa.

In some embodiments, the polyamide glass fiber composition has a bending strength of 200 to 280 MPa, preferably 240 to 280 MPa.

In some embodiments, the polyamide glass fiber composition has a bending modulus of 6500-11,000 MPa, preferably 8200-11,000 MPa.

In some embodiments, the polyamide glass fiber composition has a notched impact strength of 6.5 to 13 J/m², Preferably 7.5 to 13 J/m².

In some embodiments, the polyamide glass fiber composition has flame property of UL94 up to V-0 grade, and/or a limiting oxygen index of 26.5% (V/V) or more, preferably 27-33% (V/V).

In some embodiments, the polyamide glass fiber composition has a heat distortion temperature of 190 to 280° C., preferably 220 to 280° C.

The present disclosure also provides a molded article formed with the flame-retardant polyamide glass fiber composition.

The flame-retardant polyamide glass fiber composition of the present disclosure has excellent moldability and can be processed into molded articles of various shapes by molding methods such as injection molding, blow molding, extrusion, compression molding, drawing, drawing, vacuum molding, and the like.

In some embodiments, the molding method using mould can be various molding methods such as injection molding, extrusion molding, pressure molding, and the like, and particularly, a molding method using an injection molding machine. The injection molding conditions for continuously obtaining a stable molded article are not particularly specified, but for example, the injection time is preferably 0.5-10 seconds, more preferably 2-10 seconds, and the back pressure is preferably 0.1 MPa or more, more preferably 1 MPa or more, still more preferably 2 MPa or more, and most preferably 3 MPa or more.

One embodiment of the present disclosure also provides an application of the flame-retardant polyamide glass fiber composition, wherein the flame-retardant polyamide glass fiber composition is a raw material of the following elements or molded products: electrical and electronic equipment and automotive parts such as machines, automotive interior trims, household appliances, toys, sports goods, mobile phones, computers, portable computers and the like.

The inventors of the present application blend polyamide resin with glass fiber, the polyamide resin has a bio-based pentadiamine raw material, excellent fireproof and flame-retardant properties and mechanical properties can be achieved without adding or only adding a small amount of flame retardant during blending, so that the flame-retardant plastic can meet the requirements of different plastic products, in particular to products with higher requirements on fireproof and flame-retardant properties and mechanical properties, such as new energy automotive parts, electrical and electronic equipment, intelligent household articles and other application fields.

The flame-retardant polyamide glass fiber composition disclosed by the embodiments not only has a bio-based source, but also has the flame-retardant property of UL94 up to V-0 grade, has excellent mechanical properties, and can be widely applied to the fields of various engineering plastics with higher requirements for flame-retardant effect and dimensional stability. The flame-retardant polyamide glass fiber composition and its preparation according to one embodiment of the present disclosure are further described below with reference to specific examples, in which the related tests are as follows:

1) Bending test: the test is carried out according to the standard ISO 178-2010 under a test condition of 2 mm/min. The size of a sample bar is 10 mm*4 mm*80 mm.

2) Tensile test: the test is carried out according to the standard ISO 572-2-2012 under a test condition of 5 mm/min.

3) Impact test: the test is a cantilever beam notched impact test according to the standard ISO 180/1A under a test condition of 23° C.

4) Flame-retardant rating test: UL-94 plastic flame-retardant rating includes: V-2, V-1 and V-0. Wherein V-2: the sample is subjected to two 10 s combustion tests, and the flame is extinguished within 60 s; and the dropping of burning matter can be happen; V-1: the sample is subjected to two 10 s combustion tests, and the flame is extinguished within 60 seconds; and no the dropping of burning matter; V-0: the sample is subjected to two 10 s combustion tests, and the flame is extinguished within 30 seconds; and no the dropping of burning matter.

5) Test of limiting oxygen index: limiting oxygen index (LOI) refers to the volume fraction concentration of oxygen at which a polymer can support its combustion in a mixture of oxygen and nitrogen. It can be used for characterizing combustion behavior of material and judging the difficulty of combustion of material when it is contacted with flame. The limit oxygen index can be measured by using combustion candle test, and a polymer rod is combusted downwards under the specific condition. In the present disclosure, the test method of limit oxygen index can be carried out according to ISO 4589-2.

6) Heat Deformation Temperature (HDT): the test is carried out according to the national standard GB/T 1634.2-2004, the size of the sample is 120 mm*10 mm*4 mm (length*width*thickness), and the applied bending stress is 1.8 MPa.

The raw materials used in the following examples and comparative examples are commercially available unless otherwise specified:

1. Polyamide resin PA56/5T-1: a relative viscosity of 2.62, a melting point of 270° C., a moisture content of 1000 ppm, an amino terminal group content of 52 mmol/kg. The preparation method of the polyamide resin included as the following steps:
(1) The temperature in a salt-forming kettle was increased to 65° C., and water, pentanediamine and a diacid (adipic acid and terephthalic acid with a molar ratio of 1:0.45) were mixed in a nitrogen atmosphere to prepare an aqueous polyamide salt solution with a concentration of 65 wt %; the molar ratio of pentanediamine to the diacid was 1.05:1;
(2) the aqueous polyamide salt solution was transferred into a polymerization kettle, and heated under nitrogen atmosphere, the temperature in the kettle was increased to 290° C., and the pressure in the polymerization kettle was increased to 1.5 MPa, maintaining for 100 minutes; then in 80 minutes, the gas was exhausted and the pressure was decreased to normal pressure while the temperature in the polymerization kettle was increased to 310° C.; the polymerization kettle was vacuumed to reduce the pressure inside by −0.05 Mpa, maintaining for 60 minutes to obtain the described polyamide resin PA56/5T-1.

2. Polyamide resin PA56/5T-2: a relative viscosity of 2.81, a melting point of 278° C., a moisture content of 1600 ppm, an amino terminal group content of 50 mmol/kg. The preparation method of the polyamide resin PA56/5T-2 referred to the above preparation method of the polyamide resin PA56/5T-1, with the difference that the raw material diacids for preparing the polyamide resin were adipic acid and terephthalic acid in a molar ratio of 1:0.61.

3. E-glass fiber, M-glass fiber and S-glass fiber with a length of 3 mm, all were available from Taishan Glass Fiber Co., Ltd.

4. Polyamide resin PA56/5T-3: a relative viscosity of 2.4, a melting point of 298° C., a moisture content of 800 ppm, an amino terminal group content of 52 mmol/kg. The preparation method of the polyamide resin PA56/5T-3 referred to the above preparation method of the polyamide resin PA56/5T-1, with the difference that the raw material diacids for preparing the polyamide resin were adipic acid and terephthalic acid in a molar ratio of 1:0.9 and the temperature in the polymerization kettle was increased to 325° C.

### Example 1

The flame-retardant polyamide glass fiber composition was prepared from the following raw materials in parts by weight:

61 parts of polyamide resin PA56/5T-1, 30 parts of 3 mm E-glass fibers, 8 parts of flame retardant aluminum diethylhypophosphite, 0.2 parts of antioxidant 1098, 0.2 parts of antioxidant 168, 0.3 parts of internal lubricant WAX-E, and 0.3 parts of external lubricant WAX-C.

The preparation method of the flame-retardant polyamide glass fiber composition included the following steps of:
(1) adding the polyamide resin, the flame retardant, the antioxidant, the internal lubricant and the external lubricant into a stirrer for mixing to obtain a premix;
(2) melt-mixing the premix at 295° C., and simultaneously feeding glass fibers into the premix from the side feed of a parallel twin-screw extruder, mixing, extruding and cooling to obtain the flame-retardant polyamide glass fiber composition.

During melt-mixing, the premix was fed into the parallel twin-screw extruder through a feeder for melt extrusion and granulation. Wherein, the parallel twin-screw extruder was in an eight-zone heating mode, and the temperatures of the first zone to the eighth zone (in the direction from feed to machine head) were 260° C., 280° C., 290° C., 290° C., 290° C., 290° C., 290° C., 290° C., 290° C., 290° C. in sequence. The temperature of the machine head was 285° C. The rotation speed of the screw was 400 r/min. The rotation speed of main feeding was 20 r/min. The rotation speed of side feeding was 5.2 r/min. The aspect ratio of the twin-screw extruder was 1:36.

### Example 2

The flame-retardant polyamide glass fiber composition was prepared from the following raw materials in parts by weight:

59 parts of polyamide resin PA56/5T-1, 30 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E, and 0.3 parts external lubricant WAX-C. The preparation method of the composition was the same as the Example 1.

### Example 3

The flame-retardant polyamide glass fiber composition was prepared from the following raw materials in parts by weight:

57 parts of polyamide resin PA56/5T-1, 30 parts of 3 mm E-glass fibers, 12 parts of flame retardant aluminum diethylhypophosphite, 0.2 parts of antioxidant 1098, 0.2 parts of antioxidant 168, 0.3 parts of internal lubricant WAX-E, 0.3 parts of external lubricant WAX-C. The preparation method of the composition was the same as the Example 1.

### Example 4

The flame-retardant polyamide glass fiber composition was prepared from the following raw materials in parts by weight:

64 parts of polyamide resin PA56/5T-1, 25 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E, and 0.3 parts of external lubricant WAX-C. The preparation method of the composition was the same as the Example 1.

### Example 5

The flame-retardant polyamide glass fiber composition was prepared from the following raw materials in parts by weight:

56 parts of polyamide resin PA56/5T-1, 33 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E, and 0.3 parts of external lubricant WAX-C. The preparation method of the composition was the same as that of Example 1.

### Example 6

The raw materials and preparation method of the flame-retardant polyamide glass fiber composition were the same as those of the Example 1, and the difference was that the polyamide resin was PA56/5T-2.

### Example 7

The flame-retardant polyamide glass fiber composition was prepared from the following raw materials in parts by weight:

49 parts of polyamide resin PA56/5T-1, 40 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E, 0.3 parts of external lubricant WAX-C. The preparation method of the composition was the same as the Example 1.

### Example 8

The flame-retardant polyamide glass fiber composition was prepared from the following raw materials in parts by weight:

59 parts of polyamide resin PA56/5T-1, 30 parts of 3 mm E-glass fibers, 10 parts of flame retardant melamine aluminum polyphosphate, 0.2 parts of antioxidant 1098, 0.2 parts of antioxidant 168, 0.3 parts of internal lubricant WAX-E, 0.3 parts of external lubricant WAX-C. The preparation method of the composition was the same as the Example 1.

### Example 9

The flame-retardant polyamide glass fiber composition was prepared from the following raw materials in parts by weight:

59 parts of polyamide resin PA56/5T-1, 30 parts of 3 mm E-glass fibers, 10 parts of flame retardant decabromodiphenyl oxide, 0.2 parts of antioxidant 1098, 0.2 parts of antioxidant 168, 0.3 parts of internal lubricant WAX-E, and 0.3 parts of external lubricant WAX-C. The preparation method of the composition was the same as the Example 1.

### Example 10

The flame-retardant polyamide glass fiber composition was prepared from the following raw materials in parts by weight: 59 parts of polyamide resin PA56/5T-1, 30 parts of 3 mm E-glass fibers, 8 parts of flame retardant aluminum diethylhypophosphite, 2 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 11

The flame-retardant polyamide glass fiber composition was prepared from the following raw materials in parts by weight: 59 parts of polyamide resin PA56/5T-1, 30 parts of 3 mm E-glass fibers, 8 parts of flame retardant melamine aluminum polyphosphate, 2 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 12

The flame-retardant polyamide glass fiber composition was prepared from the following raw materials in parts by weight: 59 parts of polyamide resin PA56/5T-1, 30 parts of 3 mm S-glass fibers, 8 parts of flame retardant aluminum diethylhypophosphite, 2 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 13

The flame-retardant polyamide glass fiber composition was prepared from the following raw materials in parts by weight: 59 parts of polyamide resin PA56/5T-1, 30 parts of 3 mm M-glass fibers, 8 parts of flame retardant aluminum diethylhypophosphite, 2 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 14

The flame-retardant polyamide glass fiber composition was prepared from the following raw materials in parts by weight: 59 parts of polyamide resin PA56/5T-1, 30 parts of 3 mm E-glass fibers, 5 parts of flame retardant aluminum diethylhypophosphite, 5 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 15

The flame-retardant polyamide glass fiber composition was prepared from the following raw materials in parts by weight: 59 parts of polyamide resin PA56/5T-1, 30 parts of 3 mm E-glass fibers, 2 parts of flame retardant aluminum diethyl hypophosphite, 8 parts of flame retardant decabromodiphenyl oxide, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 16

The polyamide resin composition was prepared from the following raw materials in parts by weight: 59 parts of polyamide resin PA56/5T-1, 30 parts of 3 mm E-glass fibers, 8 parts of flame retardant aluminum hydroxide, 0.2 parts of antioxidant 1098, 0.2 parts of antioxidant 168, 0.3 parts of internal lubricant WAX-E and 0.3 parts of external lubricant WAX-C

The polyamide resin composition preparation method included the steps of:
(1) adding the polyamide resin, the flame retardant, the antioxidant, the internal lubricant and the external lubricant into a stirrer for mixing to obtain a premix;
(2) melt-kneading the premix at a temperature of 290° C., and simultaneously feeding glass fibers from a side feed of a parallel twin-screw extruder to the premix, mixing, extruding and cooling to obtain the resin composition.

During melt-mixing, the premix was fed into the parallel twin-screw extruder through a feeder for melt extrusion and granulation. Wherein, the twin-screw extruder was in an eight-zone heating mode, and the temperatures in the first zone to the eighth zone (in the direction from feed to machine head) were 260° C., 280° C., 290° C., 290° C., 290° C., 290° C., 290° C., 290° C., 290° C., and 290° C. in sequence. The temperature of the machine head was 285° C. The rotation speed of the screw was 400 r/min. The rotation speed of main feeding was 20 r/min. The rotation speed of side feeding was 5.2 r/min. The aspect ratio of the twin-screw extruder was 1:36.

### Comparative Example 1

A polyamide resin composition was prepared from the following raw materials (containing no glass fiber) in parts by weight:

89 parts of polyamide resin PA56/5T-1, 10 parts of flame retardant aluminum diethylhypophosphite, 0.2 parts of antioxidant 1098, 0.2 parts of antioxidant 168, 0.3 parts of internal lubricant WAX-E, and 0.3 parts of external lubricant WAX-C.

The polyamide resin composition preparation method included the steps of:
(1) adding the polyamide resin, flame retardant, antioxidant, internal lubricant and external lubricant into a stirrer for mixing to obtain a premix;
(2) melt-kneading, mixing, extruding and cooling the premix at a temperature of 290° C. to obtain the resin composition.

During melt-mixing, the premix was fed into a parallel twin-screw extruder through a feeder for melt extrusion and granulation. Wherein, the twin-screw extruder was in an eight-zone heating mode, and the temperatures of the first zone to the eighth zone (in the direction from feed to machine head) were 260° C., 280° C., 290° C., 290° C., 290° C., 290° C., 290° C., 290° C., 290° C., and 290° C. in sequence. The temperature of the machine head was 285° C. The rotation speed of the screw was 400 r/min. The rotation speed of main feeding was 20 r/min. The rotation speed of side feeding was 5.2 r/min. The aspect ratio of the twin-screw extruder was 1:36.

### Comparative Example 2

The polyamide glass fiber composition was prepared from the following raw materials in parts by weight: 69 parts of polyamide resin PA56/5T-1, 20 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E and 0.3 parts of external lubricant WAX-C. The preparation method of the composition was the same as that of the Example 1.

### Example 17

The flame-retardant polyamide glass fiber composition was prepared from the following raw materials in parts by weight:

56 parts of polyamide resin PA56/5T-3, 33 parts of 3 mm E-glass fibers, 10 parts of flame retardant aluminum diethylhypophosphite, 0.2 parts of antioxidant 1098, 0.2 parts of antioxidant 168, 0.3 parts of internal lubricant WAX-E, and 0.3 parts of external lubricant WAX-C.

The preparation method of the flame-retardant polyamide glass fiber composition included the following steps of:
(1) adding the polyamide resin, the flame retardant, the antioxidant, the internal lubricant and an external lubricant into a stirrer for mixing to obtain a premix;
(2) melt-mixing the premix at 315° C., and simultaneously feeding glass fibers into the premix from the side feed of a parallel twin-screw extruder, mixing, extruding and cooling to obtain the flame-retardant polyamide glass fiber composition.

During melt-mixing, the premix was fed into the parallel twin-screw extruder through a feeder for melt extrusion and granulation. Wherein, the parallel twin-screw extruder was in an eight-zone heating mode, and the temperatures of the first zone to the eighth zone (in the direction from feed to machine head) were 290° C., 290° C., 315° C., 315° C., 315° C., 315° C., 315° C., 315° C., 315° C., 315° C. in sequence. The temperature of the machine head was 310° C. The rotation speed of the screw was 400 r/min. The rotation speed of main feeding was 20 r/min. The rotation speed of side feeding was 5.2 r/min. The aspect ratio of the twin-screw extruder was 1:36.

Performance tests were performed on the resin compositions obtained in the above examples and comparative examples, and the data obtained are shown in Table 1.

TABLE 1

| | | | | Notched | | Limiting | |
|---|---|---|---|---|---|---|---|
| | Tensile | Bending | Bending | impact | Flame-retardant | oxygen | Heat |
| | strength | strength | modulus | strength | property | index | deformation |
| Test Item | (MPa) | (MPa) | (MPa) | (J/m²) | (1.5 mm) | (%) | (180 MPa/° C.) |
| Example1 | 185 | 259 | 8711 | 8.4 | V-0 | 26.9 | 234 |
| Example2 | 184 | 258 | 8832 | 9.3 | V-0 | 29.6 | 235 |
| Example3 | 182 | 256 | 8647 | 8.2 | V-0 | 32.2 | 232 |
| Example4 | 165 | 203 | 6591 | 6.7 | V-0 | 29.5 | 194 |
| Example5 | 197 | 269 | 9573 | 10.8 | V-0 | 28.7 | 241 |
| Example6 | 175 | 251 | 8342 | 7.8 | V-0 | 29.2 | 226 |
| Example7 | 215 | 275 | 10152 | 12.5 | V-0 | 29.1 | 247 |
| Example8 | 183 | 255 | 8629 | 8.6 | V-0 | 28.5 | 233 |
| Example9 | 184 | 257 | 8816 | 8.4 | V-0 | 29.5 | 235 |
| Example10 | 197 | 262 | 8892 | 8.7 | V-0 | 31.3 | 237 |
| Example11 | 183 | 254 | 8289 | 8.1 | V-0 | 29.4 | 231 |
| Example12 | 189 | 256 | 8625 | 8.3 | V-0 | 30.9 | 234 |
| Example13 | 185 | 257 | 9139 | 8.5 | V-0 | 30.8 | 235 |
| Example14 | 181 | 247 | 8479 | 8.0 | V-0 | 29.6 | 232 |
| Example15 | 182 | 249 | 8527 | 8.1 | V-0 | 29.7 | 233 |
| Example16 | 173 | 246 | 8273 | 7.5 | V-0 | 27.6 | 221 |
| Comparative | 76 | 113 | 2985 | 5.2 | V-1 | 28.9 | 84 |
| Example | | | | | | | |
| 1 | | | | | | | |
| Comparative | 144 | 185 | 4961 | 6.2 | V-0 | 29.4 | 173 |
| Example | | | | | | | |
| 2 | | | | | | | |
| Example17 | 199 | 273 | 9645 | 11.2 | V0 | 29.4 | 272 |

It can be seen from can be seen from the results of Table 1 that by co-mixing polyamide resin containing bio-base raw material (pentanediamine) and glass fiber, the flame-retardant polyamide glass fiber composition can be obtained, whose fire-retardant property can be up to V-0 grade in UL94, and mechanical property is excellent, so that it can be extensively used in the field of various engineering plastics with high requirements for flame-retardant effect and dimensional stability.

Unless otherwise defined, all terms used in the present disclosure have the meanings commonly understood by those of ordinary skill in the art.

The embodiments described in the present disclosure are only for exemplary purposes and are not intended to limit the protection scope of the present disclosure. Those skilled in the art can make various other substitutions, changes and improvements within the scope of the present disclosure. Therefore, the present disclosure is not limited to the above-described embodiments, but only by the claims.

1. A flame-retardant polyamide glass fiber composition comprising 40-65 parts by mass of a polyamide resin, 25-40 parts by mass of glass fibers, 0-20 parts by mass of a flame retardant, 0.2-1 part by mass of an antioxidant and 0.1-2 parts by mass of other auxiliaries;
wherein the polyamide resin comprising repeat units derived from pentanediamine and a diacid; wherein the diacid comprises an aliphatic diacid and an aromatic diacid; the aliphatic diacid is selected from succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, and octadecanedioic acid; the aromatic diacid comprises one or more of terephthalic acid, isophthalic acid, phthalic acid, and a mixture thereof; and
the molar ratio of pentanediamine to the diacid is 1-1.05:1.

2. The flame-retardant polyamide glass fiber composition according to claim 1, wherein the diacids are adipic acid and terephthalic acid, and the molar ratio of adipic acid to terephthalic acid is 1:0.1-1.5.

3. The flame-retardant polyamide glass fiber composition according to claim 1, wherein the relative viscosity of the polyamide resin in 96% concentrated sulfuric acid at 25° C. is 1.8-4.

4. The flame-retardant polyamide glass fiber composition according to claim 1, wherein the polyamide resin has a melting point of 200-318° C.5. The flame-retardant polyamide glass fiber composition according to claim 1, wherein the glass fibers are selected from any one of E-Glass fiber, S-Glass fiber, D-Glass fiber, C-Glass fiber, L-Glass fiber, and M-Glass fiber.

6. The flame-retardant polyamide glass fiber composition according to claim 1, wherein the glass fibers are chopped glass fibers having a length of 3-5 mm.

7. The flame-retardant polyamide glass fiber composition according to claim 1, wherein the flame retardant is selected from one or more of a phosphorus-containing flame retardant, a halogen flame retardant, a nitrogen-based flame retardant and an inorganic flame retardant.

8. The flame-retardant polyamide glass fiber composition according to claim 1, wherein the flame retardant is selected from any two of aluminum diethylhypophosphite, decabromodiphenyl ether, and melamine polyphosphate.

9. The flame-retardant polyamide glass fiber composition according to claim 1, wherein the flame retardant is a combination of aluminum diethylhypophosphite and decabromodiphenyl ether, and the weight ratio of aluminum diethylhypophosphite to decabromodiphenyl ether is 3 to 5:1.

10. The flame-retardant polyamide glass fiber composition according to claim 1, wherein the antioxidant is selected from one or more of hindered phenolic antioxidants, hindered amine antioxidants, or phosphite antioxidants;

11. The flame-retardant polyamide glass fiber composition according to claim 10, wherein the antioxidant is selected from one or more of commercially available antioxidant 168, antioxidant 1098, antioxidant 1010, and antioxidant S9228.

12. The flame-retardant polyamide glass fiber composition according to claim 1, wherein the other auxiliaries include one or more of lubricants, colorants, UV absorbers, light stabilizers, antistatic agents, and plasticizers.

13. The flame-retardant polyamide glass fiber composition according to claim 1, wherein the other auxiliaries include an internal lubricant such as montan wax, and an external lubricant such as amide wax, stearate or ethylenebis-stearamide.

14. The flame-retardant polyamide glass fiber composition according to claim 1, wherein the flame-retardant polyamide glass fiber composition has a tensile strength of 170-220 MPa, and/or a bending strength of 200-280 MPa, and/or a bending modulus of 6500-11000 MPa, and/or a notched impact strength of 6.5-13 J/m², and/or, a flame-retardant property of UL94 up to V-0 grade, a limiting oxygen index of 26.5% (V/V) or more, and/or a heat deformation temperature of 190-280° C.

15. A preparation method of the flame-retardant polyamide glass fiber composition according to claim 1, comprising: mixing the polyamide resin, the glass fibers, the flame retardant, the antioxidant and other auxiliaries, preferably kneading by a melt extruder, and more preferably kneading by a twin-screw extruder.

16. The preparation method according to claim 15, comprising: adding the polyamide resin, the flame retardant, the antioxidant and other auxiliaries into the stirrer, and mixing to obtain a premix, then melt-mixing the premix at 15-40° C. higher than the melting point of the polyamide resin, and adding the glass fibers into the premix, mixing, extruding and cooling to obtain the flame-retardant polyamide glass fiber composition.

17. The preparation method according to claim 15, comprising: during melt-kneading, the premix is fed into a parallel twin-screw extruder through a feeder for melt extrusion, and granulation, in which the parallel twin-screw extruder is in eight-zone heating mode, and its technological parameters are as follows: the temperature of the first zone is 250-270° C., the temperature of the second zone is 270-290° C., the temperature of the third zone is 290-320° C., the temperature of the fourth zone is 290-320° C., the temperature of the fifth zone is 290-320° C., the temperature of the sixth zone is 290-320° C., the temperature of the seventh zone is 290-320° C. and the temperature of the eighth zone is 290-320° C., in which the direction from the first zone to the eighth zone is the direction from feed inlet to machine head.

18. The preparation method according to claim 15, wherein the machine head temperature of the twin-screw extruder is 285-315° C.

19. The preparation method according to claim 15, wherein the twin-screw extruder has a screw rotation speed of 350-500 r/min.

20. The preparation method according to claim 15, wherein the main feed rotation speed of the twin-screw extruder is 10-100 r/min, and the side feed rotation speed of the twin-screw extruder is 1-100 r/min.
